(19) United States
(12) Patent Application Publication
(10) Pub. No.: US 2018/0014508 A1
(43) Pub. Date: Jan. 18, 2018

(54) Pet Sanitary Pant

(71) Applicant: WHARNEY DAILY CHEMICAL, Zhejiang (CN)

(72) Inventor: Lei Fang, Zhejiang (CN)

(21) Appl. No.: 15/208,919

(22) Filed: Jul. 13, 2016

(51) Int. Cl. A01K 23/00; A01K 13/00

(52) U.S. Cl. CPC A01K 23/00; A01K 13/006

(57) ABSTRACT

Disclosed is a pet sanitary pant, including a flaky water absorption body and a main body part that clamps and fixes the water absorption body and at least has a double-layer structure; the main body part includes an upper girdle part and lower girdle part at both ends of a length direction; adhesion parts are arranged at both ends of a width direction of the lower girdle part for adhering the upper girdle part to cylindrically cover a pet waist during wearing; a tail passing part for a pet tail to pass through is arranged at a hip position on the main body part; and a stereoscopic wrinkle part capable of erecting towards the pet skin is arranged on the inner side of the length direction of the lower girdle part. Due to the technical solution, excrement overflow from the pet waist is prevented to better guarantee cleanness.

### Field of the Invention

The present invention relates to a pet sanitary pant, and belongs to the technical field of pet wearing sanitary products.

### BACKGROUND OF THE INVENTION

In recent years, people raising dogs, cats and other pets have been increasing continuously. As a habit, pets conduct a micturition behavior not purely as a physiological phenomenon, but also as a mark for claiming their territory sometimes. Therefore, if the pets are raised indoors, the problems of micturition on the wall surfaces of rooms, furniture and the like to pollute the indoor spaces are present. For the indoor micturition, adult dogs can be trained to micturate at a specified location, but for puppies born newly, small dogs younger than one year old, and old dogs, it is difficult to realize. In order to solve the above problems, a sanitary pant worn on pets is known. As shown in FIGS. 1 and 2, the existing pet sanitary pant generally includes a water absorption body and a main body part 1 that clamps and fixes the water absorption body and at least has a double-layer structure, and a hole 2 for a pet tail 100b to pass through is arranged at a hip 100a position on the main body part 1 during wearing of a pet 100. The edge of the hole 2 is connected to a folded part 3, the edge of the folded part 3 corresponds to the edge of the hole 2, that is, the folded part 3 is a part cut on the main body part 1 along a cutting line 5 for forming the opening and is not completely separated from the main body part 1 after cutting, while one edge is connected with the main body part 1, so when in use, after the folded part 3 is folded, the tail 100b passes through the hole 2 (see FIG. 2). The structure has the following problems when in use, during pet wearing, the excrement of the pet is likely to leak from a position located at the waist of the pet on the main body part 1, and particularly when the excrement is excessive, the excrement is very likely to flow out from the waist.

### SUMMARY OF THE INVENTION

Therefore, the object of the present invention is to provide a pet sanitary pant, which can prevent the excrement of a pet from easily flowing out from the waist.

To achieve the above object, the pet sanitary pant of the present invention includes a flaky water absorption body and a main body part that clamps and fixes the water absorption body and at least has a double-layer structure; the main body part includes an upper girdle part and a lower girdle part located at both ends of a length direction; adhesion parts are arranged at both ends of a width direction of the lower girdle part for adhering the upper girdle part to cylindrically cover a pet waist during pet wearing; a tail passing part for a pet tail to pass through is arranged at a hip position on the main body part during pet wearing; and a stereoscopic wrinkle part capable of erecting towards the pet skin during wearing is arranged on the inner side of the length direction of the lower girdle part.

Stereoscopic wrinkle parts capable of erecting towards the pet skin during wearing are also respectively arranged at left and right side edges in the width direction of the main body part.

The tail passing part includes a hole penetrating through both the main body part and the water absorption part, and an isolation part; the isolation part includes a cylindrical part attached to the inner side wall of the hole within a range of 360° in the circumferential direction, two annular parts respectively connected with two axial ends of the cylindrical part, and a flaky part located on the inner side of the cylindrical part; the two annular parts clamp the main body part; and a cross opening is formed on the flaky part for the pet tail to pass through.

The tail passing part includes a U-shaped opening formed in an area not clamping water absorption part on the main body part; and two linear grooves are formed at positions close to the arc part of the U-shaped opening on the main body part.

The upper and lower girdle parts are provided with elastic rubber band areas.

Two mutually parallel grooves extending along the length direction are arranged on at least one side face of the water adsorption body, and the grooves are sunken towards the inner side of the water adsorption body.

Extension parts extending towards both sides of the width direction are respectively arranged at both ends of the length direction of the water adsorption body.

By adopting the above technical solutions, according to the pet sanitary pant of the present invention, the upper and lower girdle parts cylindrically cover the pet waist during pet wearing, since the stereoscopic wrinkle part is arranged on the inner side of the length direction of the lower girdle part, the stereoscopic wrinkle part can erect towards the skin side of the pet during wearing, therefore when the pet excretes, even if the excretion volume is relatively large, the stereoscopic wrinkle part can block the excrement to prevent the excrement from flowing out from the waist, so as to better guarantee the cleanness.

### BRIEF DESCRIPTION OF THE DRAWINGS

FIG. 1 is a schematic diagram of a structure of a pet sanitary pant in the prior art before pet wearing.

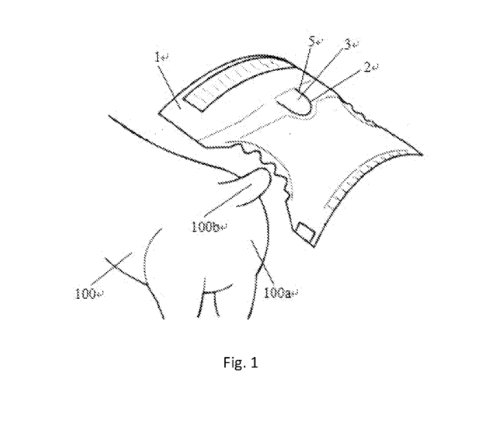

FIG. 2 is a schematic diagram of a structure of a pet sanitary pant in the prior art during pet wearing.

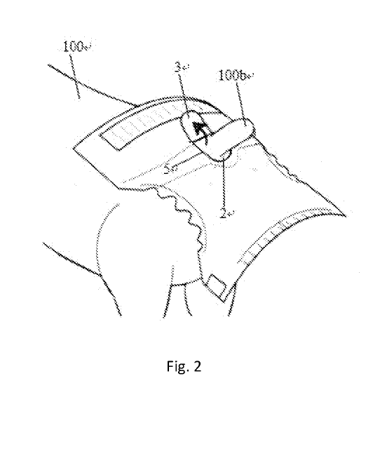

FIG. 3 is a top view of a pet sanitary pant of the present invention.

FIG. 4 is a bottom view of a pet sanitary pant of the present invention.

FIG. 5 is a stereoscopic schematic diagram of a pet sanitary pant of the present invention.

FIG. 6 is a schematic diagram of another implementation structure of a water absorption body in the present invention.

FIG. 7 is a section view of an A-A direction in FIG. 6.

FIG. 8 is a section view of a B-B direction in FIG. 3.

FIG. 9 is a top view of a pet sanitary pant with another tail passing part implementation structure.

FIG. 10 is a stereoscopic schematic diagram of FIG. 9.

### DETAILED DESCRIPTION OF THE EMBODIMENTS

The present invention will be further illustrated below in detail through the accompany drawings and specific embodiments.

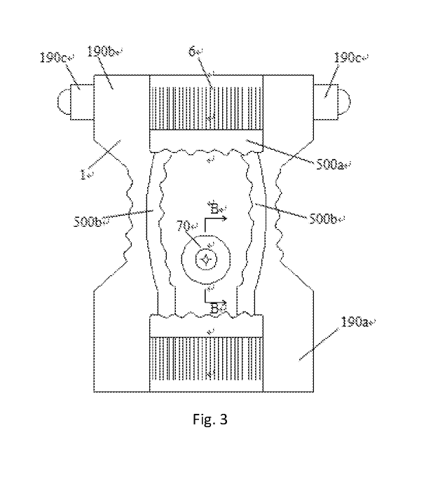

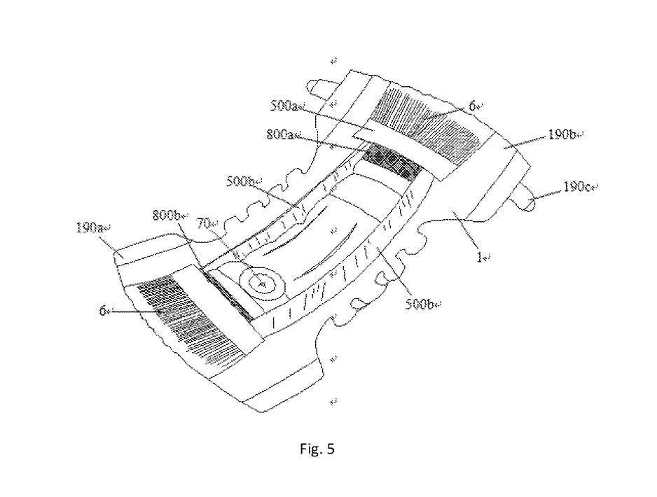

As shown in FIGS. 3, 4 and 5, the embodiment provides a pet sanitary pant, including a flaky water absorption body 900 and a main body part 1 that clamps and fixes the water absorption body 900 and at least has a double-layer structure; the main body part 1 includes an upper girdle part 190a and a lower girdle part 190b located at both ends of a length direction; and adhesion parts 190c are arranged at both ends of a width direction of the lower girdle part 190b for adhering the upper girdle part 190a to cylindrically cover a pet waist during pet wearing.

A tail passing part 70 for a pet tail to pass through is arranged at a hip position on the main body part 1 during pet wearing.

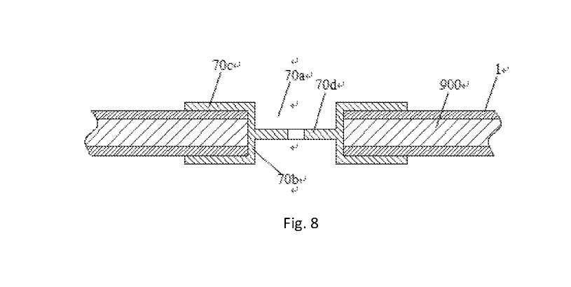

As shown in FIG. 8, the tail passing part 70 includes a hole 70a penetrating through both the main body part and the water absorption part, and an isolation part; the isolation part includes a cylindrical part 70b attached to the inner side wall of the hole 70a within a range of 360° in the circumferential direction, two annular parts 70c respectively connected with two axial ends of the cylindrical part 70b, and a flaky part 70d located on the inner side of the cylindrical part 70b; the two annular parts 70c clamp the main body part 1; and a cross opening 70e is formed on the flaky part 70d for the pet tail to pass through.

The tail passing part 70 having the above structure can solve the problem in the prior art that a hole or a groove is directly formed on the main body part 1 and the water absorption part 900, so that the internal tissues (for example, fluff pulp, wood chips and the like) of the water absorption part are likely to leak out, and the isolation part completely closes the inner side wall of the hole, therefore the internal tissues of the water absorption part are unlikely to leak out when the sanitary pant is used, so as to guarantee the cleanness of the domestic environment.

Waterproof non-woven fabric areas 800a, 800b are arranged at positions located at both sides of the length direction of the water absorption body 900 on the main body part 1. The waterproof non-woven fabric areas can hold the pet excrement and block the position of the water absorption body during pet wearing, so as to prevent the excrement from flowing to the position without the water absorption body and leaking out.

A stereoscopic wrinkle part 500a capable of erecting towards the pet skin during wearing is arranged on the inner side of the length direction of the lower girdle part 190b.

During pet wearing, the upper and lower girdle parts 190a, 190b cylindrically cover the pet waist, since the stereoscopic wrinkle part 500a is arranged on the inner side of the length direction of the lower girdle part 190b, the stereoscopic wrinkle part 500a can erect towards the skin side of the pet during wearing, therefore when the pet excretes, even if the excretion volume is relatively large, the stereoscopic wrinkle part 500a can block the excrement to prevent the excrement from flowing out from the waist, so as to better guarantee the cleanness.

Meanwhile, stereoscopic wrinkle parts 500b capable of erecting towards the pet skin during wearing are also respectively arranged at left and right side edges in the width direction of the main body part 1.

The upper and lower girdle parts 190a and 190b are provided with elastic rubber band areas 6, so the upper and lower girdle parts 190a and 190b can elastically wrap the pet waist to ensure more close-fit and more comfortable pet wearing.

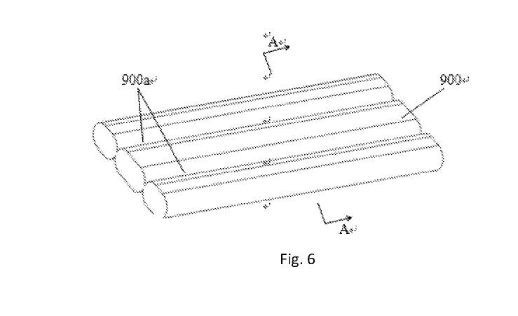

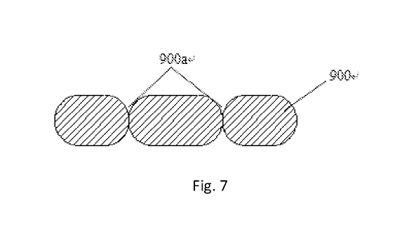

As shown in FIGS. 6 and 7, grooves 900a extending along the length direction are arranged on at least one side face of the water adsorption body 900, the grooves 900a are sunken towards the inner side of the water adsorption body 900, and the grooves 900a are two mutually parallel grooves.

The grooves 900a are arranged on both the upper and lower surfaces of the water adsorption body 900.

During pet wearing, the water adsorption body is clamped between two legs, the water adsorption body is generally bent, the existing water adsorption body is generally provided with three grooves, compared with the prior art, two grooves 900a are provided, when being bent, the water adsorption body is bent along the two grooves 900a to form three parts, and the middle part in the three bent parts can be uniformly applied with the force of the two side parts, so that the overall structure is more stable, will not shake easily and can better adapt to the clamping of the two legs of the pet, so as to ensure more comfortable pet wearing.

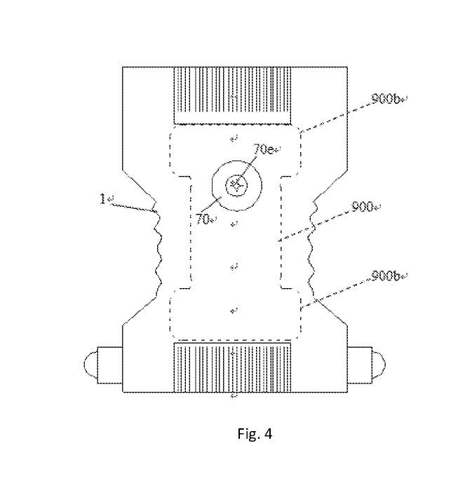

As shown in FIG. 4, another embodiment of the water adsorption body 900 is in the shape as shown in a dotted line in the figure, extension parts 900b extending towards both sides of the width direction are respectively arranged at both ends of the length direction of the water adsorption body 900. This structural configuration has the beneficial effects that: during pet wearing, the two legs of the pet clamp the middle part of the water adsorption body 900, so the middle part cannot be too wide, otherwise, the pet wears it uncomfortably, in this way, such a structure is kept that the middle part of the water adsorption body 900 is narrow, the extension parts 900b are arranged to guarantee the water adsorption body 900 has an enough water adsorption amount, and moreover, the extension parts 900b will not be clamped by the two legs of the pet, therefore generating no discomfort to the pet.

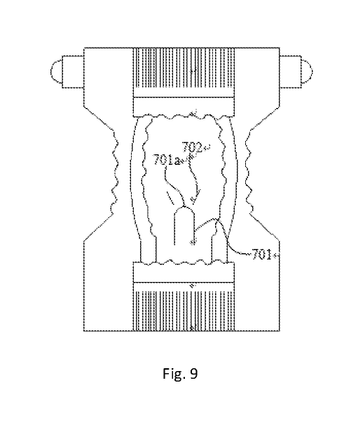

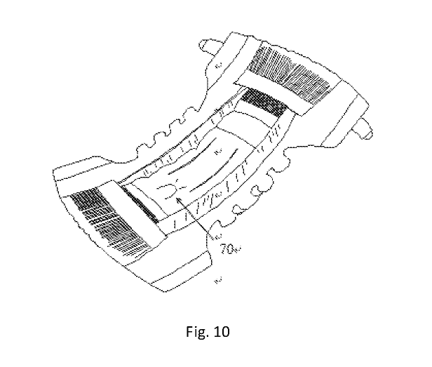

As shown in FIGS. 9 and 10, as another embodiment, the tail passing part 70 includes a U-shaped opening 701 formed in an area not clamping water absorption part on the main body part; and two linear grooves 702 are formed at positions close to the arc part 701a of the U-shaped opening 701 on the main body part. When in use, the isolation area between the two linear grooves 702 and the arc part 701a can be torn apart to expand the aperture to meet different demands of various thicknesses of pet tails.

Obviously, the above embodiments are merely examples listed for clear illustration, rather than limiting the embodiments. Those of ordinary skill in the art can also make other modifications or variations in different forms on the basis of the above illustration. It is neither necessary nor possible to exhaust all embodiments. Obvious modifications or variations derived thereby still fall into the protection scope of the present invention-creation.

1. A pet sanitary pant, comprising a flaky water absorption body and a main body part that clamps and fixes the water absorption body and at least has a double-layer structure, wherein the main body part comprises an upper girdle part and a lower girdle part located at both ends of a length direction; adhesion parts are arranged at both ends of a width direction of the lower girdle part for adhering the upper girdle part to cylindrically cover a pet waist during pet wearing; a tail passing part for a pet tail to pass through is arranged at a hip position on the main body part during pet wearing; and a stereoscopic wrinkle part capable of erecting towards the pet skin during wearing is arranged on the inner side of the length direction of the lower girdle part.

2. The pet sanitary pant of claim 1, wherein stereoscopic wrinkle parts capable of erecting towards the pet skin during wearing are also respectively arranged at left and right side edges in the width direction of the main body part.

3. The pet sanitary pant of claim 1, wherein the tail passing part comprises a hole penetrating through both the main body part and the water absorption part, and an isolation part; the isolation part comprises a cylindrical part attached to the inner side wall of the hole within a range of 360° in the circumferential direction, two annular parts respectively connected with two axial ends of the cylindrical part, and a flaky part located on the inner side of the cylindrical part; the two annular parts clamp the main body part; and a cross opening is formed on the flaky part for the pet tail to pass through.

4. The pet sanitary pant of claim 1, wherein the tail passing part comprises a U-shaped opening formed in an area not clamping water absorption part on the main body part; and two linear grooves are formed at positions close to the arc part of the U-shaped opening on the main body part.

5. The pet sanitary pant of claim 1, wherein the upper and lower girdle parts are provided with elastic rubber band areas.

6. The pet sanitary pant of claim 2, wherein the upper and lower girdle parts are provided with elastic rubber band areas.

7. The pet sanitary pant of claim 3, wherein the upper and lower girdle parts are provided with elastic rubber band areas.

8. The pet sanitary pant of claim 4, wherein the upper and lower girdle parts are provided with elastic rubber band areas.

9. The pet sanitary pant of claim 1, wherein two mutually parallel grooves extending along the length direction are arranged on at least one side face of the water adsorption body, and the grooves are sunken towards the inner side of the water adsorption body.

10. The pet sanitary pant of claim 2, wherein two mutually parallel grooves extending along the length direction are arranged on at least one side face of the water adsorption body, and the grooves are sunken towards the inner side of the water adsorption body.

11. The pet sanitary pant of claim 3, wherein two mutually parallel grooves extending along the length direction are arranged on at least one side face of the water adsorption body, and the grooves are sunken towards the inner side of the water adsorption body.

12. The pet sanitary pant of claim 4, wherein two mutually parallel grooves extending along the length direction are arranged on at least one side face of the water adsorption body, and the grooves are sunken towards the inner side of the water adsorption body.

13. The pet sanitary pant of claim 1, wherein extension parts extending towards both sides of the width direction are respectively arranged at both ends of the length direction of the water adsorption body.

14. The pet sanitary pant of claim 2, wherein extension parts extending towards both sides of the width direction are respectively arranged at both ends of the length direction of the water adsorption body.

15. The pet sanitary pant of claim 3, wherein extension parts extending towards both sides of the width direction are respectively arranged at both ends of the length direction of the water adsorption body.

16. The pet sanitary pant of claim 4, wherein extension parts extending towards both sides of the width direction are respectively arranged at both ends of the length direction of the water adsorption body
